(19) United States
(12) Patent Application Publication
(10) Pub. No.: US 2026/0298334 A1
(43) Pub. Date: Oct. 1, 2026

(54) SHIFT-BY-WIRE APPARATUS

(71) Applicant: Isuzu Motors Limited, Yokohama-shi (JP)

(72) Inventors: Pongsathon SRISUWAN, Samutprakan (TH); Rianpanya FA-AMNUYPOL, Samutprakan (TH)

(73) Assignee: Isuzu Motors Limited, Yokohama-shi (JP)

(21) Appl. No.: 19/564,392

(22) Filed: Mar. 12, 2026

(30) Foreign Application Priority Data
Mar. 26, 2025 (JP) 2025-052279

(51) Int. Cl. F16H 59/10; B60K 20/04

(52) U.S. Cl. CPC F16H 59/105; B60K 20/04

(57) ABSTRACT

A shift-by-wire apparatus of the present disclosure includes: a first sensor that is driven by a first power supply and that outputs a first detection signal corresponding to a position of a shift lever; a second sensor that is driven by a second power supply different from the first power supply and that outputs a second detection signal corresponding to the position of the shift lever; and a controller that controls an operation state of a transmission based on a detection signal of at least one of the first sensor and/or the second sensor.

### CROSS REFERENCE TO RELATED APPLICATIONS

This application claims the benefit of priority of Japanese Patent Application No. 2025-52279 filed on Mar 26, 2025, the contents of which are incorporated by reference as if fully set forth herein in their entirety.

### Technical Field

The present disclosure relates to a shift-by-wire apparatus.

### Background Art

In recent years, a shift-by-wire apparatus has generally been used in a transmission system of a vehicle. The shift-by-wire apparatus detects the position of a shift lever by a sensor and controls an operation state of a transmission based on a detection signal output from the sensor. Such a shift-by-wire apparatus is described in, for example, Patent Literature (hereinafter, referred to as PTL) 1 and the like.

### Citation List

### Patent Literature

### PTL 1

Japanese Patent Application Laid-Open No. 2007-198574

### Summary of Invention

### Technical Problem

Incidentally, in the shift-by-wire apparatus, the transmission may not be appropriately controlled when the position of the shift lever cannot be detected by the sensor or the detection accuracy is reduced due to a failure or the like.

The present disclosure has been made in consideration of the above point and provides a shift-by-wire apparatus that can improve reliability of detection of the shift lever position.

### Solution to Problem

On aspect of the present disclosure is a shift-by-wire apparatus that includes: a first sensor that is driven by a first power supply and that outputs a first detection signal corresponding to a position of a shift lever; a second sensor that is driven by a second power supply different from the first power supply and that outputs a second detection signal corresponding to the position of the shift lever; and a controller that controls an operation state of a transmission based on a detection signal of at least one of the first sensor and/or the second sensor.

### Advantageous Effects of Invention

According to the present disclosure, reliability of detection of the shift lever position can be improved.

### BRIEF DESCRIPTION OF DRAWINGS

FIG. 1 is an exploded perspective view of a configuration of a shift lever according to an embodiment;

FIG. 2 is a diagram for describing a positional relationship between magnets and digital and analog sensors;

FIG. 3 is a schematic diagram illustrating a shift position in the example of the embodiment;

FIG. 4A is a diagram illustrating the position of a pin when a lever shaft is set to the P position;

FIG. 4B is a diagram illustrating the position of the pin during transition of the lever shaft from the P position to the R position;

FIG. 4C is a diagram illustrating the position of the pin when the lever shaft is set to the R position;

FIG. 5 is an exploded perspective view for illustrating a relationship between the lever shaft and a sensor board;

FIG. 6 is a diagram illustrating a relationship between a digital output from the digital sensor and the shift position;

FIG. 7 is a diagram illustrating a relationship between an analog output from the analog sensor and the shift position;

FIG. 8 is a block diagram illustrating a schematic configuration of a vehicle equipped with the shift-by-wire apparatus according to the embodiment; and

FIG. 9 is a flowchart for describing shift-by-wire processing according to the embodiment.

### DESCRIPTION OF EMBODIMENTS

Hereinafter, the embodiment of the present invention will be described with reference to the drawings.

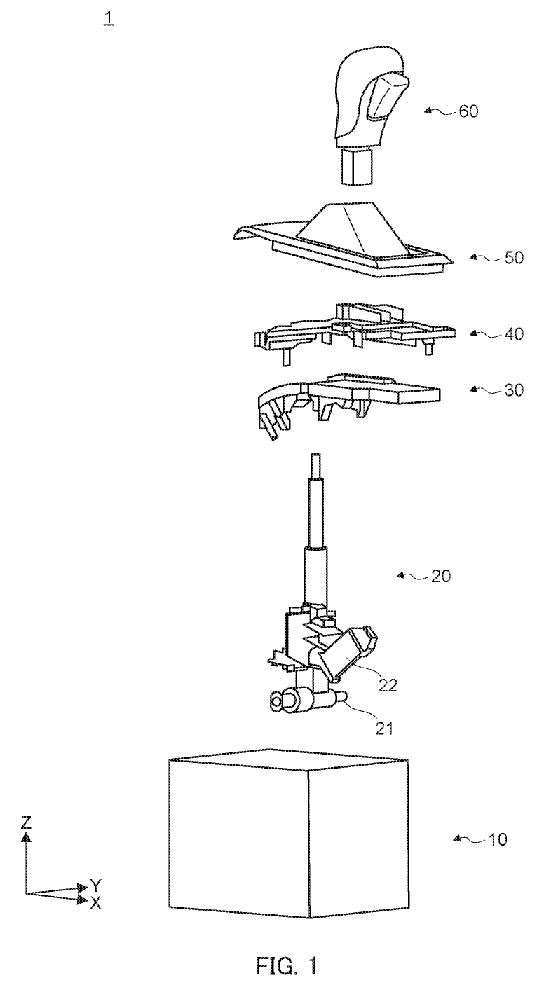

FIG. 1 is an exploded perspective view of a configuration of shift lever 1 according to the embodiment. Shift lever 1 includes shift lever body 10, lever shaft 20, guide cover 30, upper cover 40, shift boot 50, and shift knob 60.

Shift lever body 10 is fixed to a vehicle body beside the driver’s seat. Lever shaft 20 includes rotation shaft 21 on the lower side. Rotation shaft 21 is rotatably attached to shift lever body 10.

Guide cover 30 is attached to an opening portion of shift lever body 10 at the upper portion. An opening portion through which a shaft portion of lever shaft 20 penetrates is formed in a central portion of guide cover 30. Thus, the lower base portion of lever shaft 20 is stored in shift lever body 10, and the shaft portion on the upper side protrudes upward from guide cover 30.

Shift knob 60 is connected to the upper end tip of lever shaft 20. Thus, when shift knob 60 is operated by the driver, lever shaft 20 rotates about rotation shaft 21 in response to the operation.

Shift boot 50 and upper cover 40 are fixed to the vehicle body and have a structure that covers guide cover 30 without interfering with the movement of shift knob 60 and lever shaft 20 during shift operation.

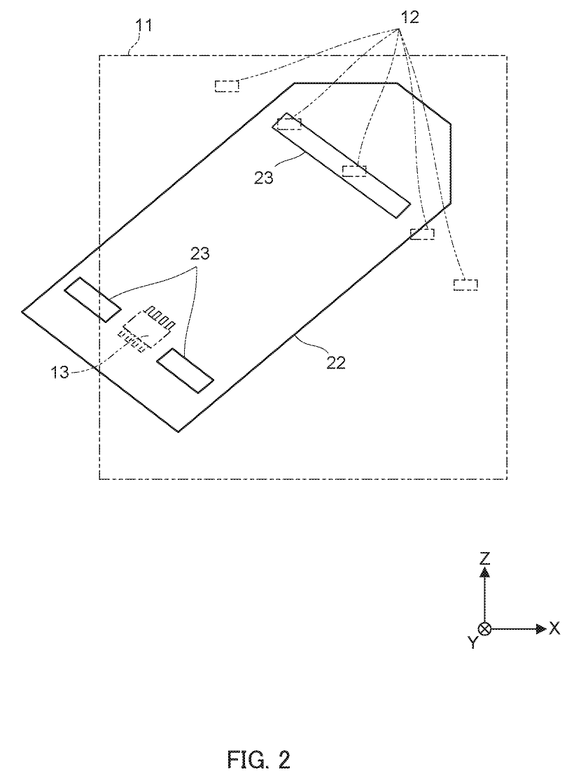

Magnet mounting portion 22 is provided on lever shaft 20. Magnet mounting portion 22 is provided at a position above rotation shaft 21 and below a shaft body of lever shaft 20. As illustrated in FIG. 2, magnets 23 for detecting a rotation position of lever shaft 20 are fixedly provided on magnet mounting portion 22.

In addition, as shown by a chain line in FIG. 2, sensor board 11 is provided at a position in shift lever body 10 facing magnet mounting portion 22. Digital sensor 12 and analog sensor 13 are provided on sensor board 11. Digital sensor 12 outputs a voltage corresponding to a relative position to magnet 23 by four Hall ICs. Analog sensor 13 outputs a voltage corresponding to the relative position to magnet 23 by one Hall IC. Thus, digital sensor 12 and analog sensor 13 each output a detection signal corresponding to the rotation position of lever shaft 20. Note that the numbers of Hall ICs of digital sensor 12 and analog sensor 13 are not limited to the example in FIG. 2.

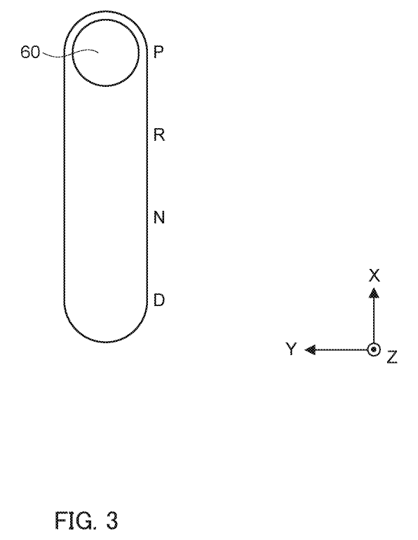

FIG. 3 illustrates a shift position in the example of the present embodiment. Shift lever 1 is set to any of a P (parking position), an R (reverse position), an N (neutral position), or a D (drive position) in response to the operation of shift knob 60 by the driver.

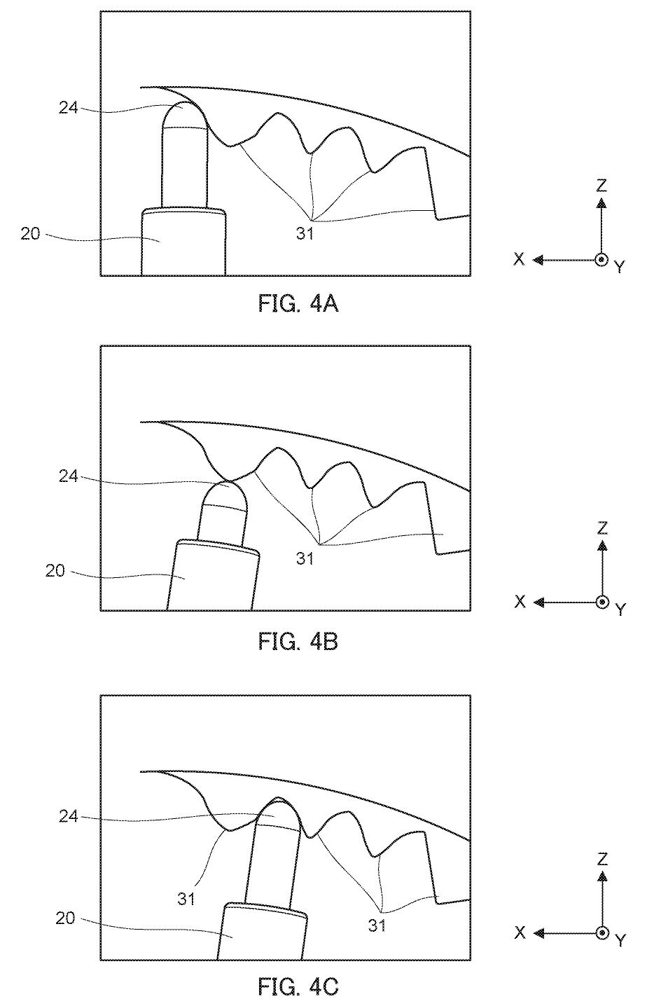

A plurality of detents 31 as illustrated in FIGS. 4A to 4C are formed on the lower surface of guide cover 30. Meanwhile, pin 24 as a contact member is provided on the side surface of lever shaft 20 facing detents 31. Pin 24 is pressed against detents 31 by a spring force. Pin 24 transitions to any position of detents 31 in response to the rotation of lever shaft 20 by the driver.

FIG. 4A illustrates the position of pin 24 when lever shaft 20 is set to the P position. FIG. 4B illustrates a position of pin 24 during transition of lever shaft 20 from the P position to the R position. FIG. 4C illustrates a position of pin 24 when lever shaft 20 is set to the R position.

The P, R, N, and D positions are determined depending on which recessed portion of detent 31 pin 24 is fitted into. The shift change is performed by the driver applying, to lever shaft 20, a rotation force equal to or greater than a certain force such that pin 24 passes over detent 31.

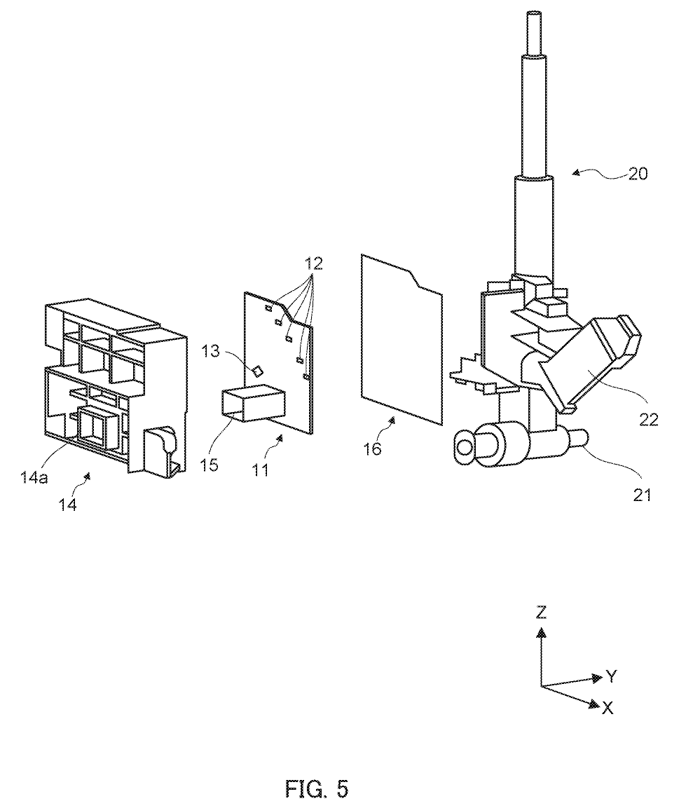

FIG. 5 is an exploded perspective view for describing a relationship between lever shaft 20 and sensor board 11.

Sensor board 11 is fixed to base 14 by, for example, a screw. Base 14 is fixed inside shift lever body 10 by, for example, a screw. Accordingly, digital sensor 12 and analog sensor 13 of sensor board 11 are disposed to face magnet 23 (see FIG. 2) of magnet mounting portion 22.

In addition, sensor board 11 includes connector 15. Connector 15 is fitted into through-hole 14a of base 14. A wiring harness of the vehicle is connected to connector 15. This allows power supplies for digital sensor 12 and analog sensor 13 to be supplied to digital sensor 12 and analog sensor 13 through the wiring harness, and outputs of digital sensor 12 and analog sensor 13 to be output to an electronic control unit (ECU) of the vehicle through the wiring harness.

In addition, for example, seal 16 made of a material having excellent strength, non-magnetic properties, and electrical insulation, such as polycarbonate, is adhered to a surface of sensor board 11 facing magnet mounting portion 22.

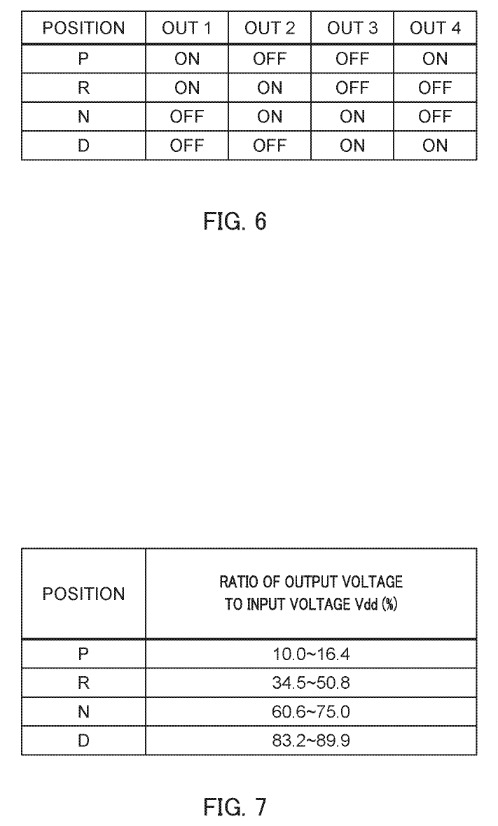

FIG. 6 is a diagram illustrating a relationship between the digital output from digital sensor 12 and the shift position. FIG. 7 is a diagram illustrating a relationship between the analog output from analog sensor 13 and the shift position. In FIG. 6, the terms “OUT1,” “OUT2,” “OUT3,” and “OUT4” indicate digital signals respectively output from digital sensors 12.

Note that, although the number of digital sensors 12 is five, the number of outputs is four because, in the example of the present embodiment, the outputs of two of the digital sensors are combined into a single output for one digital sensor pair. For example, the outputs of two digital sensors 12 on the right side in FIG. 2 are combined and output as “OUT4.”

The values shown in FIG. 7 indicate ratios of the output voltage to the input voltage Vdd of analog sensor (Hall IC) 13.

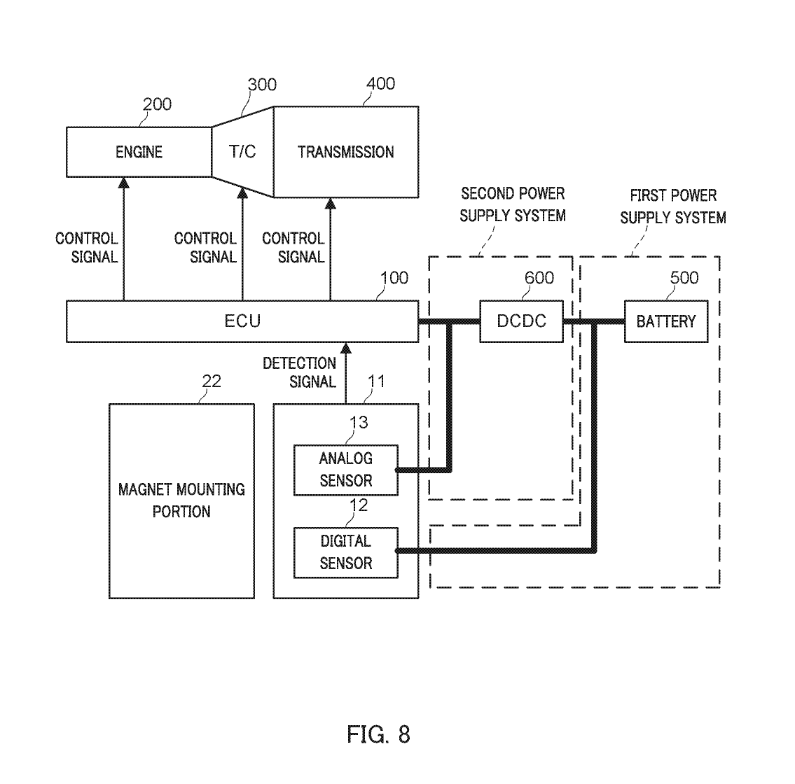

FIG. 8 is a block diagram illustrating a schematic configuration of a vehicle equipped with the shift-by-wire apparatus according to the present embodiment.

The shift-by-wire apparatus includes magnet mounting portion 22, sensor board 11, and ECU 100 as a controller. As described above, magnet mounting portion 22 includes magnet 23. Sensor board 11 includes digital sensor 12 and analog sensor 13. ECU 100 controls engine 200, torque converter (T/C) 300, and transmission 400. Transmission 400 is controlled to any of the P, R, N, or D operation states by ECU 100.

Digital sensor 12 inputs a battery voltage (12 [V]) from battery 500 as a power supply. In contrast, analog sensor 13 inputs a voltage that is stepped down from 12 [V] to 5 [V] by DCDC converter 600 as a power supply.

In other words, digital sensor 12 inputs a voltage of a first power supply system, whereas analog sensor 13 inputs a voltage of a second power supply system different from the voltage of the first power supply system. Note that ECU 100 also inputs the voltage (5 [V]) of the second power supply system.

The detection signal output from digital sensor 12 and the detection signal output from analog sensor 13 are transmitted to ECU 100. ECU 100 controls the operation state of transmission 400 based on at least one of the detection signal output from digital sensor 12 and/or the detection signal output from analog sensor 13.

Specifically, ECU 100 stores the relationship between the outputs (detection signals) of digital sensor 12 and analog sensor 13 illustrated in FIGS. 6 and 7 and the shift position as a table. ECU 100 determines which shift position the input detection signal corresponds to by referring to the table. Then, ECU 100 controls transmission 400 such that the operation state of transmission 400 corresponds to the shift position obtained as a result of the determination.

ECU 100 includes a processor constituted by a central processing unit (CPU), read only memory (ROM), random access memory (RAM), and the like as main components. ECU 100 executes a predetermined program to output a control signal for controlling engine 200, torque converter (T/C) 300, and transmission 400. All or a part of ECU 100 may be formed of a hard-wired circuit such as an application specific integrated circuit (ASIC) or a field-programmable gate array (FPGA).

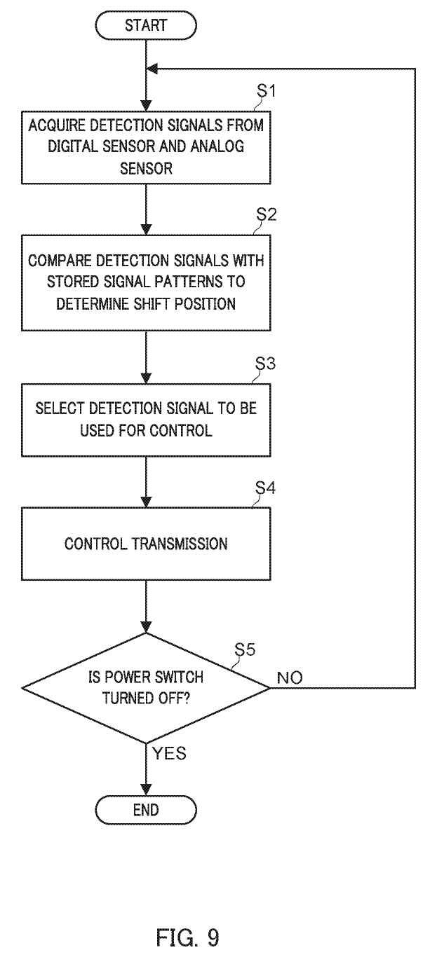

Next, shift-by-wire processing according to the present embodiment will be described with reference to the flowchart in FIG. 9.

In Step S1, ECU 100 acquires detection signals from digital sensor 12 and analog sensor 13.

In Step S2, ECU 100 compares the detection signals with the stored signal patterns to determine the shift position. Specifically, ECU 100 compares the detection signals with the signal patterns as illustrated in FIGS. 6 and 7 to determine which shift position the input detection signals correspond to.

In Step S3, ECU 100 selects the detection signal to be used for control.

When the shift position based on the detection signal of digital sensor 12 and the shift position based on the detection signal of analog sensor 13 are the same as each other in the determination result in Step S2, ECU 100 selects any detection signal of the detection signal of digital sensor 12 and the detection signal of analog sensor 13 in Step S3. For example, in a case where the setting is made in advance to preferentially use the detection signal of digital sensor 12 over the detection signal of analog sensor 13, the detection signal of digital sensor 12 is selected.

On the other hand, when the shift position based on the detection signal of digital sensor 12 and the shift position based on the detection signal of analog sensor 13 are different from each other in the determination result in Step S2, ECU 100 determines which sensor has higher reliability and selects the detection signal having higher reliability.

For example, ECU 100 diagnoses the reliability of digital sensor 12 and analog sensor 13 based on whether an abnormal value appears in the detection signal. That is, ECU 100 has a function of diagnosing digital sensor 12 and analog sensor 13, and selects, based on the diagnosis result, the detection signal to be used for controlling transmission 400 from the detection signal of digital sensor 12 and the detection signal of analog sensor 13.

In Step S4, ECU 100 controls transmission 400 based on the detection signal selected in Step S3.

In Step S5, ECU 100 determines whether a power switch (which may be referred to ignition switch) is turned off, and ends the shift-by-wire processing when the power switch is turned off. On the other hand, when the power switch is not turned off, ECU 100 returns to Step S1 and repeats the above-described processing.

As described above, according to the present embodiment, the following form is adopted.

(1) One aspect of the present embodiment is a shift-by-wire apparatus that includes: a first sensor (digital sensor 12) that is driven by a first power supply and outputs a first detection signal corresponding to a position of shift lever 1; a second sensor (analog sensor 13) that is driven by a second power supply different from the first power supply and outputs a second detection signal corresponding to the position of shift lever 1; and a controller (ECU 100) that controls an operation state of transmission 400 based on a detection signal of at least one of the first sensor and/or the second sensor (digital sensor 12 and analog sensor 13).

As a result, since the first sensor and the second sensor are driven by different power supplies, even when a malfunction occurs in either the first power supply or the second power supply, the position of shift lever 1 can be detected based on the detection signal from the sensor driven by the power supply in which no malfunction has occurred. Consequently, the reliability of position detection of shift lever 1 can be improved.

(2) In the shift-by-wire apparatus according to one aspect of the present embodiment, in the above (1), the first sensor includes a plurality of sensors and is digital sensor 12 that outputs digital signals corresponding to the position of shift lever 1 from the plurality of sensors, and the second sensor is analog sensor 13 that outputs an analog signal corresponding to the position of shift lever 1.

As described above, by making the first sensor and the second sensor sensors having different configurations, the probability that both sensors fail can be reduced, and the reliability of the position detection of shift lever 1 can be further improved.

(3) In the shift-by-wire apparatus according to one aspect of the present embodiment, in the above (1), a voltage of the first power supply is equal to the voltage of battery 500, and a voltage of the second power supply is equal to a power supply voltage of the controller (ECU 100).

(4) In the shift-by-wire apparatus according to one aspect of the present embodiment, in the above (1), the first power supply belongs to a power supply system (first power supply system) of battery 500, and the second power supply belongs to a power supply system (second power supply system) of the controller (ECU 100) that steps down the voltage of battery 500.

As a result, the probability that both the first power supply and the second power supply are unusable due to disconnection or the like can be reduced, and the reliability of the position detection of shift lever 1 can be further improved. That is, since the power supply system (first power supply system) of battery 500 and the power supply system (second power supply system) of the controller (ECU 100) are often provided with different wirings, the possibility that the disconnection occurs in both power supply systems is reduced, and the probability that both the first power supply and the second power supply are unusable is reduced.

(5) In the shift-by-wire apparatus according to one aspect of the present embodiment, in the above (1), the controller (ECU 100) has a function of diagnosing the first sensor (digital sensor 12) and the second sensor (analog sensor 13), and selects, based on the diagnosis result, the detection signal to be used for controlling transmission 400 from the first detection signal and the second detection signal.

The above-described embodiment merely describes an example of specific implementation for practicing the present disclosure, and should not be construed as limiting the technical scope of the present disclosure. That is, the present disclosure can be carried out in various forms without departing from the spirit and the main features thereof.

In the above-described embodiment, the case has been described in which the first sensor is digital sensor 12 and the second sensor is analog sensor 13, but the present invention is not limited thereto, and both the first sensor and the second sensor may be digital sensors or analog sensors. However, as described above, by making the first sensor and the second sensor sensors having different configurations, there is an advantage that the probability that both sensors fail can be reduced.

In the above-described embodiment, the case has been described in which digital sensor 12 is driven by the battery voltage (12 [V]) and analog sensor 13 is driven by the same voltage (5 [V]) as ECU 100, but the present invention is not limited thereto. For example, digital sensor 12 may be driven by the same voltage (5 [V]) as ECU 100, and analog sensor 13 may be driven by the battery voltage (12 [V]). In addition, both digital sensor 12 and analog sensor 13 may be driven by the same voltage. The point is that the first sensor and the second sensor are preferably powered from different power supply systems. Here, the different power supply systems mean power supplies supplied through different wiring harnesses.

In the above-described embodiment, the case has been described in which the shift-by-wire apparatus according to the present disclosure is applied to the vehicle including engine 200, but the present invention is not limited thereto. The shift-by-wire apparatus according to the present disclosure can also be applied to, for example, an electric vehicle including a transmission.

### Industrial Applicability

The shift-by-wire apparatus according to the present disclosure can be widely applied when controlling a transmission according to the position of a shift lever.

### REFERENCE SIGNS LIST

1 Shift lever

10 Shift lever body

11 Sensor board

12 Digital sensor

13 Analog sensor

14 Base

15 Connector

16 Seal

20 Lever shaft

21 Rotation shaft

22 Magnet mounting portion

23 Magnet

24 Pin

30 Guide cover

31 Detent

40 Upper cover

50 Shift boot

60 Shift knob

100 ECU

400 Transmission

500 Battery

600 DCDC converter

1. A shift-by-wire apparatus, comprising:
a first sensor that is driven by a first power supply and that outputs a first detection signal corresponding to a position of a shift lever;
a second sensor that is driven by a second power supply different from the first power supply and that outputs a second detection signal corresponding to the position of the shift lever; and
a controller that controls an operation state of a transmission based on a detection signal of at least one of the first sensor and/or the second sensor.

2. The shift-by-wire apparatus according to claim 1, wherein
the first sensor includes a plurality of sensors and is a digital sensor that outputs a plurality of digital signals corresponding to the position of the shift lever from the plurality of sensors, and
the second sensor is an analog sensor that outputs an analog signal corresponding to the position of the shift lever.

3. The shift-by-wire apparatus according to claim 1, wherein
a voltage of the first power supply is equal to a battery voltage, and
a voltage of the second power supply is equal to a power supply voltage of the controller.

4. The shift-by-wire apparatus according to claim 1, wherein
the first power supply belongs to a power supply system of a battery, and
the second power supply belongs to a power supply system of the controller, the power supply system of the controller stepping down a voltage of the battery.

5. The shift-by-wire apparatus according to claim 1, wherein
the controller has a function of diagnosing the first sensor and the second sensor, and selects, based on a diagnosis result, a detection signal to be used for controlling the transmission from the first detection signal and the second detection signal.
